(19) United States
(12) Patent Application Publication
(10) Pub. No.: US 2023/0258603 A1
(43) Pub. Date: Aug. 17, 2023

(54) IDENTIFICATION AND LABELING OF DEFECTS IN BATTERY CELLS

(71) Applicant: Liminal Insights, Inc., Emeryville, CA (US)

(72) Inventors: Austin Ryan DULANEY, Emeryville, CA (US); Jason Yue YU, Castro Valley, CA (US); Shaurjo BISWAS, El Cerrito, CA (US); Andrew G. HSIEH, Berkeley, CA (US); Barry J. VAN TASELL, El Cerrito, CA (US)

(21) Appl. No.: 18/109,521

(22) Filed: Feb. 14, 2023

Related U.S. Application Data
(60) Provisional application No. 63/309,975, filed on Feb. 14, 2022.

(51) Int. Cl. G01N 29/06; H01M 10/42; G01N 29/04; G01N 29/44

(52) U.S. Cl. CPC G01N 29/069; H01M 10/4285; G01N 29/048; G01N 29/4481; G01N 29/4445

(57) ABSTRACT

The present disclosure are directed to techniques for defect detection and identification inside batteries. In one aspect, a non-invasive method of identifying and labeling defects in a battery cell includes transmitting acoustic signals through a battery cell via one or more first transducers, receiving response signals in response to the acoustic signals at one or more second transducers, determining whether at least one feature of interest exists in the battery cell based on analyzing the response signals, performing an identification and labeling process on the at least one feature of interest to determine at least one defect in the battery cell, and outputting a result of the identification and labeling process.

### CROSS REFERENCE TO RELATED APPLICATIONS

This application claims the benefit of U.S. Provisional Application No. 63/309,975, filed on Feb. 14, 2022, and entitled “IDENTIFICATION AND LABELING OF DEFECTS IN BATTERY CELLS”, the contents of which are hereby incorporated by reference in their entirety and for all purposes.

### STATEMENT REGARDING FEDERALLY SPONSORED RESEARCH OR DEVELOPMENT

This invention was made with U.S. Federal government support under Grant No. SBIR 1831080 awarded by the National Science Foundation. The government has certain rights in the invention.

### FIELD OF DISCLOSURE

Disclosed aspects are directed to acoustic inspection of batteries, more specifically, to collecting acoustic data on battery cells to detect, identify, and/or locate defects on the battery cells.

### BACKGROUND

Demand for production of battery cells is on the rise owing to an increase in their use across various industries such as consumer electronics, automotive, clean energy, etc. Efficient and fast battery diagnostics methods are important for increasing quality, lifetime, and manufacturing process efficiency for batteries. In the case of manufacturing and production, reducing costs (e.g., price per kilowatt-hour (kWh)) is an important goal. Production costs and quality can be reduced by optimizing existing processes and/or introducing new technologies. For example, technological advances in the area of improved monitoring, manufacturing, and diagnostics can lead to cost efficiencies by shortening production process times (thus also reducing energy consumption during production), reducing waste due to damaged cells and cell parts, improving quality, etc.

### BRIEF DESCRIPTION OF THE DRAWINGS

The accompanying drawings are presented to aid in the description of various aspects of the disclosure and are provided solely for illustration and not limitation.

FIG. 1 illustrates an example system for analyzing a sample using acoustic signal-based analysis according to some aspects of the present disclosure;

FIG. 2 illustrates another example system for analyzing a sample using acoustic signal-based analysis according to some aspects of the present disclosure;

FIG. 3 illustrates an example process flow for defect detection and identification according to some aspects of the present disclosure;

FIG. 4 illustrates an example method of defect detection and labeling according to some aspects of the present disclosure;

FIGS. 5A-D illustrate four non-limiting examples of defects identified in acoustic scan of battery cells according to some aspects of the present disclosure;

FIG. 6 illustrates an example of a labeled and segmented image of a battery cell with identified defects according to some aspects of the present disclosure;

FIG. 7 illustrates an example neural network that can be utilized for labeling and location defects according to some aspects of the present disclosure; and

FIG. 8 illustrates an example computing device architecture of an example computing device according to some aspects of the disclosure.

### SUMMARY

Aspects of the present disclosure are directed to techniques for detection, identification, and/or locating defects inside batteries during the manufacturing process and/or in post-production use of the batteries.

In one aspect, a non-invasive method of identifying and labeling defects in a battery cell includes transmitting acoustic signals through a battery cell via one or more first transducers, receiving response signals in response to the acoustic signals at one or more second transducers, determining whether at least one feature of interest exists in the battery cell based on analyzing the response signals, performing an identification and labeling process on the at least one feature of interest to determine at least one defect in the battery cell, and outputting a result of the identification and labeling process.

In another aspect, the identification and labeling process is performed using a trained machine learning model.

In another aspect, the machine learning model receives as input, at least one of the response signals and the at least one feature of interest and provides at least one labeled defect corresponding to the at least one feature, as output.

In another aspect, the identification and labeling process determines at least one of a corresponding type for the at least one defect and a corresponding location of the at least one defect in the battery cell.

In another aspect, the at least one defect is one or more of a fold, a wrinkle, one or more holes in materials forming the battery cell, cracks or fractures in solid-state ceramic based separators of the battery cell, dry spots within the battery cell, electrode holes, folds, delamination, or layer misalignment, foreign object debris, burrs, metallic particle inclusions, tab defects including tears, folds, and poor quality welds, plating of lithium metal on anode material of the battery cell, evolution of gasses resulting from electrolyte or other chemical decomposition.

In another aspect, the output is a segmented visual rendering of the battery cell with the least one defect labeled therein.

In another aspect, the method further includes determining a corrective action to be taken with respect to the battery cell based on the result of the identification and the labeling process.

In one aspect, a system includes a plurality of transducers configured to at least one of transmit and receive acoustic signals through a battery cell, and a controller communicatively coupled to the plurality of transducers. The controller is and configured to control a first subset of the plurality of transducers to transmit acoustic signals through the battery cell, control a second subset of the plurality of transducers to receive response signals in response to the acoustic signals, determine whether at least one feature of interest exists in the battery cell based on analyzing the response signals, perform an identification and labeling process on the at least one feature of interest to determine at least one defect in the battery cell, and output a result of the identification and labeling process.

In another aspect, the controller is configured to perform the identification and labeling process is performed using a trained machine learning model.

In another aspect, the machine learning model receives as input, at least one of the response signals and the at least one feature of interest and provides at least one labeled defect corresponding to the at least one feature, as output.

In another aspect, the controller is configured to perform the identification and labeling process to determine at least one of a corresponding type for the at least one defect and a corresponding location of the at least one defect in the battery cell.

In another aspect, the at least one defect is one or more of a fold, a wrinkle, one or more holes in materials forming the battery cell, cracks or fractures in solid-state ceramic based separators of the battery cell, dry spots within the battery cell, electrode holes, folds, delamination, or layer misalignment, foreign object debris, burrs, metallic particle inclusions, tab defects including tears, folds, and poor quality welds, plating of lithium metal on anode material of the battery cell, evolution of gasses resulting from electrolyte or other chemical decomposition.

In another aspect, the output is a segmented visual rendering of the battery cell with the least one defect labeled therein.

In another aspect, the processor is further configured to determine a corrective action to be taken with respect to the battery cell based on the result of the identification and the labeling process.

In one aspect, one or more non-transitory computer-readable media include computer-readable instructions, which when executed by a controller of a system for non-invasive inspection of batteries, cause the controller to control a first subset of a plurality of transducers to transmit acoustic signals through a battery cell, control a second subset of the plurality of transducers to receive response signals in response to the acoustic signals, determine whether at least one feature of interest exists in the battery cell based on analyzing the response signals, perform an identification and labeling process on the at least one feature of interest to determine at least one defect in the battery cell, and output a result of the identification and labeling process.

In another aspect, the execution of the computer-readable instructions causes the controller to perform the identification and labeling process using a trained machine learning model.

In another aspect, the machine learning model receives as input, at least one of the response signals and the at least one feature of interest and provides at least one labeled defect corresponding to the at least one feature, as output.

In another aspect, the execution of the computer-readable instructions causes the controller to perform the identification and labeling process to determine at least one of a corresponding type for the at least one defect and a corresponding location of the at least one defect in the battery cell.

In another aspect, the at least one defect is one or more of a fold, a wrinkle, one or more holes in materials forming the battery cell, cracks or fractures in solid-state ceramic based separators of the battery cell, dry spots within the battery cell, electrode holes, folds, delamination, or layer misalignment, foreign object debris, burrs, metallic particle inclusions, tab defects including tears, folds, and poor quality welds, plating of lithium metal on anode material of the battery cell, evolution of gasses resulting from electrolyte or other chemical decomposition.

In another aspect, the execution of the computer-readable instructions causes the controller to determine a corrective action to be taken with respect to the battery cell based on the result of the identification and the labeling process.

### DETAILED DESCRIPTION

Certain aspects and embodiments of this disclosure are provided in the following description and related drawings. Alternate aspects may be devised without departing from the scope of the disclosure. Additionally, well-known elements of the disclosure will not be described in detail or will be omitted so as not to obscure the relevant details of the disclosure.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the disclosure. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Demand for production of battery cells is on the rise owing to an increase in their use across various industries such as consumer electronics, automotive, clean energy, etc. A non-limiting application of battery cells is the electrical vehicle (EV) industry. According to various market research, the industry needs massive buildouts to meet EV demand by 2030 (around 15 times the current capacity). The cost of battery cell production should decrease by around 40% according to some estimates. Furthermore, as evidence thereof have already been seen, reliability of EV batteries is critical as human and financial remedies of EV recalls due to faulty batteries are immense (more than $3B in 2020-2021).

Battery manufacturing processes are not without challenges. For example, the cost of raw materials is on the rise and issues during manufacturing can lead to poor quality battery cells and hence unreliable battery cells being incorporated into and utilized in their respective applications such as in EVs, which can ultimately lead to the costly failures mentioned above.

For instance, battery defects that can lead to poor battery cell performance, a catastrophic battery (and/or device) failure, etc. Such defects can arise during the manufacturing process or during regular operation of a battery after the battery is placed in a device. Such defects are difficult to detect because they are generally deep within the battery cell and hidden from non-invasive imaging methods or are not substantial enough to be detected through electrical inspection methods until the defect has caused substantial damage/degradation to the battery.

In some examples, manufacturing defects can include, but are not limited to, folds, wrinkles, or holes in traditional polymer-based separator materials, cracks or fractures in solid-state ceramic based separators; dry spots within the cell due to poor electrolyte saturation; electrode holes, folds, delamination, or layer misalignment, foreign object debris, burrs, metallic particle inclusions, tab defects including tears, folds, and poor quality welds, electrode misalignment, electrode holes and folds, electrode material delamination, among others.

Operational defects can include, but are not limited to, the plating of lithium metal (e.g., dendritic growth or otherwise) on the anode material, dry spots within the cell due to electrolyte degradation, the evolution of gasses resulting from electrolyte or other chemical decomposition, among others. All of these defects can cause micro-shorts in the battery that, if allowed to propagate, can lead to early cell death, rapid loss of capacity, and/or catastrophic failure.

Currently available methods for studying defective batteries include x-ray or CT inspection of cell and tearing down a battery after it has been flagged as underperforming, a safety hazard, or a failure in the field.

When conducting ultrasound-based inspection tests on batteries, the wide parameter space on the test apparatus and the sample form factor can lead to challenges involving non-recurring engineering and design tasks. For example, a subset of ultrasonic test settings may be optimized to detect a folded separator in a Lithium-ion battery pouch cell, but may not be able to detect electrode inclusions in the same cell. Conversely, observing a separator fold may require different ultrasonic settings in prismatic or hard can cells versus pouch cells. The wide parameter space within ultrasound as it pertains to testing batteries can require that the test system be designed so that different transducer types can be accommodated, different test methodologies can be executed electronically, and/or that the test bed can accommodate most of the common battery form factors.

Ultrasonic tests are also highly influenced by external factors. Even in the most basic tests, results can vary drastically with fluctuations in mechanical alignment, contact force, external temperature, pressure and environment, as well as within the ultrasonic coupling used to transfer the ultrasonic pulse from the transducer to the test sample. A robustly designed ultrasonic test system as described herein can factor all of these challenges in order to produce accurate and reproducible results.

In some aspects of the present disclosure, systems, apparatuses, methods (also referred to as processes), and computer-readable media (collectively referred to herein as “systems and techniques”) are described for detecting and identifying defects inside of batteries that result from anomalies, inconsistencies, errors, or flaws that occur during the manufacturing process as well as those that develop during operation. Defect detection techniques disclosed herein are enabled through use of ultrasonic testing equipment, signal processing pipeline, and advanced analytics platform. More specifically, ultrasonic sensors may be used to send acoustic signals into battery cells and record the response signals. The response signals are then pre-processed and analyzed to extract meaningful features and metrics representing physical characteristics of a tested battery, and finally the use of the metrics to construct machine learning models to predict the presence of specific defects.

As will be described in more detail below, ultrasonic inspection platform takes measurements at multiple positions across the cell to provide high spatial resolution scans which are used to assess cell quality. Our analysis pipeline is then used to autonomously identify the presence of defects within the scanned cell, where those defects are, and what the specific defect type is based on the results from our analytics platform mentioned above. This results in a segmented image of the cell that highlights the size, location, and type of all defects present.

The disclosure begins with a description of example systems used for acoustic signal analysis of batteries.

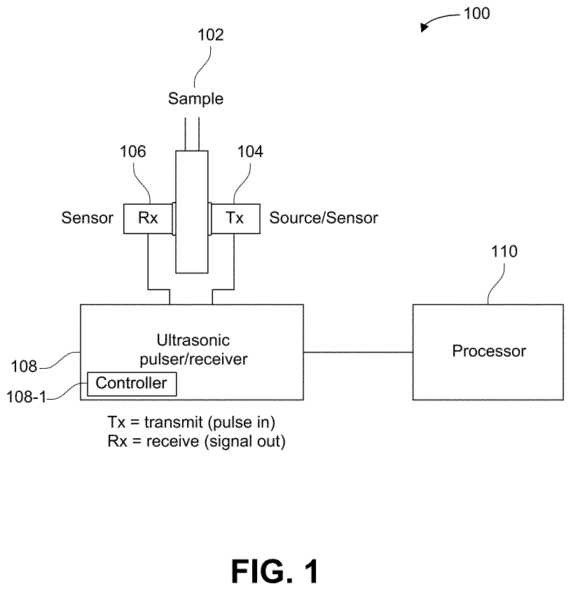

FIG. 1 illustrates an example system for analyzing a sample using acoustic signal-based analysis according to some aspects of the present disclosure. System 100 may include sample 102. Sample 102 can include a battery cell or component thereof in any stage of production or manufacture of the battery cell or the individual components. In some examples, sample 102 can include a battery cell, electrolytes in various stages of wetting/distribution through a battery cell, one or more electrodes of the battery cell, thin films, separators, coated sheets, current collectors, electrode slurries, or materials for forming any of the above components during any stage of their fabrication. System 100 can include a transmitting transducer Tx 104 or other means for sending excitation sound signals into the battery cell (e.g., for transmitting a pulse or pulses of ultrasonic or other acoustic waves, vibrations, resonance measurements, etc., through the battery cell). System 100 can further include a receiving transducer Rx 106 or other means for receiving/sensing the sound signals, which can receive response signals generated from signals transmitted by Tx transducer 104. Any type of known or to be developed transducer for transmitting and receiving acoustic signals may be used as Tx transducer 104. Transmitted signals from Tx transducer 104, from one side of sample 102 on which Tx transducer 104 is located, may include input excitation signals. Reflected signals, e.g., from another side of sample 102, may include echo signals. It is understood that references to response signals may include both the input excitation signals and the echo signals. Further, Tx transducer 104 may also be configured to receive response signals, and similarly, Rx transducer 106 may also be configured to transmit acoustic signals. Any type of known or to be developed transducer for transmitting and receiving acoustic signals may be used as Rx transducer 106. Therefore, even though separately illustrated as Tx and Rx, the functionalities of these transducers may be for both sending and receiving acoustic signals. In various alternatives, even if not specifically illustrated, one or more Tx transducers and one or more Rx transducers can be placed on the same side or wall of sample 102, or on different (e.g., opposite) sides. Throughout this disclosure, reference may be made to a transducer pair (a transmitting transducer and a receiving transducer). Transducer Tx 104 and transducer Rx 106 may form a pair of transducers.

Acoustic pulser/receiver 108 can be coupled to Tx and Rx transducers 104, 106 for controlling the transmission of acoustic signals (e.g., ultrasound signals) and receiving response signals. Acoustic pulser/receiver 108 may include a controller 108-1 for adjusting the amplitude, frequency, and/or other signal features of the transmitted signals. Acoustic pulser/receiver 108 may also receive the signals from Rx transducers 106. In some examples, acoustic pulser/receiver 108 may be configured as a combined unit, while in some examples, an acoustic pulser for transmitting excitation signals through Tx transducer 104 can be a separate unit in communication with a receiver for receiving signals from Rx transducer 106. Processor 110 in communication with acoustic pulser/receiver 108 may be configured to store and analyze the response signal waveforms according to this disclosure. Although representatively shown as a single processor, processor 110 can include one or more processors, including remote processors, cloud computing infrastructure, etc.

Although not explicitly shown in FIG. 1, more than one Tx transducer and/or more than one Rx transducer can be placed in one or more spatial locations across sample 102. This allows studying a spatial variation of acoustic signal features across sample 102. A multiplexer can be configured in communication with the acoustic pulser/receiver 108 for separating and channeling the excitation signals to be transmitted and the response signals received. In some examples, various acoustic couplants can be used (e.g., solid, liquid, or combinations thereof) for making or enhancing contact between Tx and Rx transducers 104, 106 and sample 102. Furthermore, various attachment or fixturing mechanisms (e.g., pneumatic, compression, screws, springs etc.) can also be used for establishing or enhancing the contact between Tx and Rx transducers 104, 106 and sample 102.

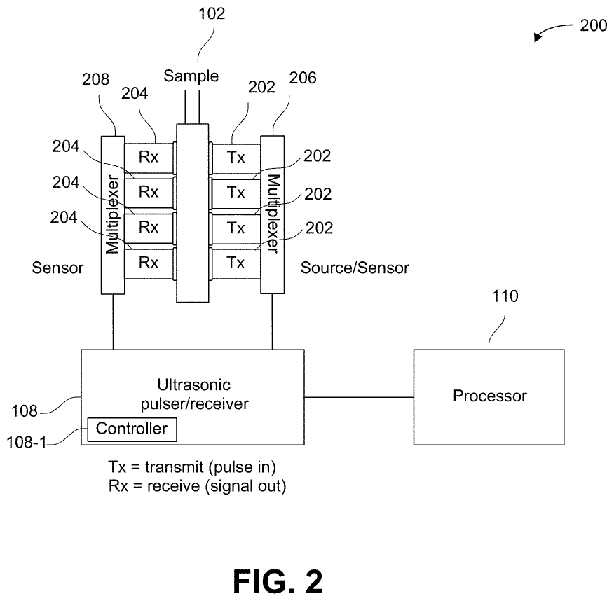

FIG. 2 illustrates another example system for analyzing a sample using acoustic signal-based analysis according to some aspects of the present disclosure. In comparison with FIG. 1, system 200 of FIG. 2 illustrates a system in which multiple pairs of transmitting and receiving transducers are used for transmitting signals through a sample under testing (e.g., a battery cell) and performing acoustic signal-based analysis of the sample.

System 200 includes several transmitting Tx transducers 202 (each of which may be the same as Tx transducer 104 of FIG. 1). While an array of four examples Tx transducers 202 are shown in FIG. 2, the disclosure is not limited to four. Any number of transducers may be used (e.g., any number of Tx transducers ranging from 1 to 10, 15, 20, etc.).

Similarly, system 200 includes a number of receiving (sensing) Rx transducers 204 (each of which may be the same as Rx transducer 106 of FIG. 1). While an array of four examples Rx transducers 204 are shown in FIG. 2, the disclosure is not limited to four. Any number of transducers may be used (e.g., any number of Rx transducers ranging from 1 to 10, 15, 20, etc.). Any given Tx transducer 202 and Rx transducer 204 may form a transducer pair (FIG. 2 illustrates four transducer pairs). FIG. 2 also illustrates a multiplexer 206 coupled to the array of four Tx transducers 202 and a multiplexer 208 coupled to the array of four Rx transducers 204. As described above, each one of multiplexers 206 and 208 may be configured in communication with the acoustic pulser/receiver 108 for separating and channeling the excitation signals to be transmitted and the response signals received, respectively. In some examples, various acoustic couplants can be used (e.g., solid, liquid, or combinations thereof) for making or enhancing contact between Tx and Rx transducers 202, 204 and sample 102. Furthermore, various attachment or fixturing mechanisms (e.g., pneumatic, compression, screws, etc.) can also be used for establishing or enhancing the contact between Tx and Rx transducers 202, 204 and sample 102. In another example, one or more pairs of transducers Tx and Rx can be translated on the surface of the sample/battery cell to collect acoustic data from various positions on the sample surface. The spatial resolution of the acoustic data collected can be controlled by moving the transducer pair(s) with certain pitch to get higher spatial coverage of the battery cell sample area.

Spacing between Tx transducers 202 and Rx transducers 204 may be uniform and the same. System 200 also includes additional elements such as sample 102, ultrasonic pulser/receiver 108 (controller 108-1), processors 110, each of which may be the same as the corresponding counterpart described above with reference to FIG. 1 and hence will not be described further for sake of brevity.

Example systems 100 and 200 may have any shape or form, may be standalone systems, may be portable or stationary, etc.

With example systems used for acoustic signal analysis of batteries described with reference to FIGS. 1 and 2, next, example methods of defect detection and identification in battery cells during manufacturing and/or post manufacturing based on acoustic measurements of the battery cells will be described.

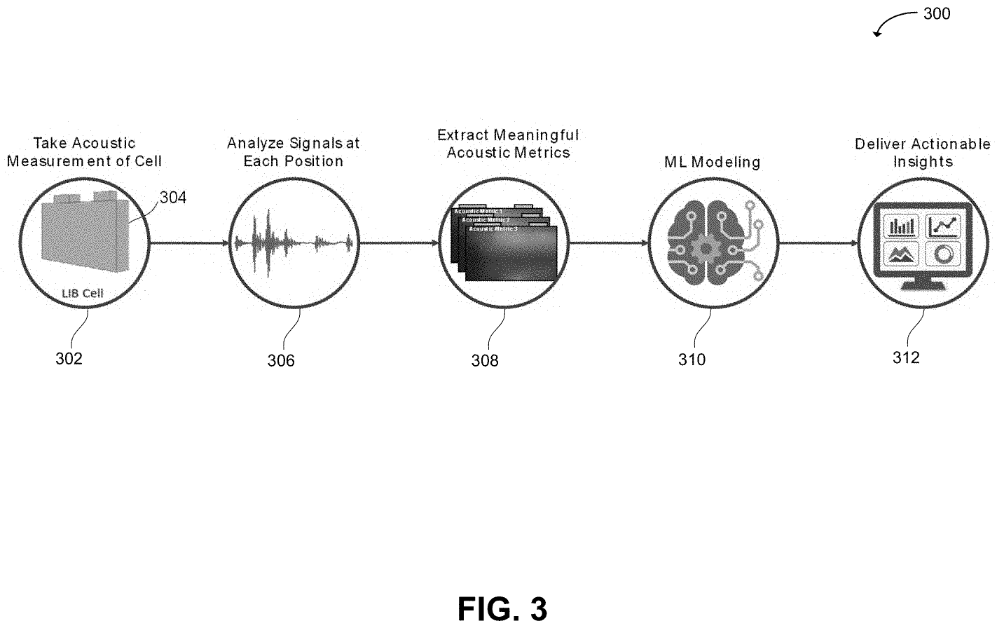

FIG. 3 illustrates an example process flow for defect detection and identification according to some aspects of the present disclosure.

A manufacturing process of a battery cell typically includes a number of stages such as wetting, formation, aging, etc. Completion of the aging process may be referred to as the end of the production line. Once a battery cell reaches the end of the production line, the battery cell may be packaged and shipped to be placed in and used within a device. The battery cell may be packaged by itself, grouped with other battery cells to form a multi-cell battery, may be placed in a module (e.g., for EV applications), etc.

Physical defects can occur throughout the lifecycle of a battery cell including during manufacturing and in post-manufacturing use. As noted above, these defects can include, but are not limited to, folds, wrinkles, or holes in traditional polymer-based separator materials, cracks or fractures in solid-state ceramic based separators, dry spots within the cell due to poor electrolyte saturation; electrode holes, folds, delamination, or layer misalignment; foreign object debris, burrs, metallic particle inclusions, tab defects including tears, folds, and poor quality welds, plating of lithium metal (e.g., dendritic growth or otherwise) on the anode material, the evolution of gasses resulting from electrolyte or other chemical decomposition, etc. All of these defects can cause micro-shorts in the battery that, if allowed to propagate, can lead to early cell death, rapid loss of capacity, and/or catastrophic failure.

Example process 300 of FIG. 3 may have several stages. The first stage may be stage 302 where a battery cell 304 undergoes acoustic measurements. Battery cell 304 maybe a Lithium-Ion Battery (LIB) cell. The acoustic measurements may be taken using example systems described above with reference to FIGS. 1 and 2. Battery cell 304 may be at any point through its manufacturing journey all the way to the end of the production line and/or may be in use in post-manufacturing stage.

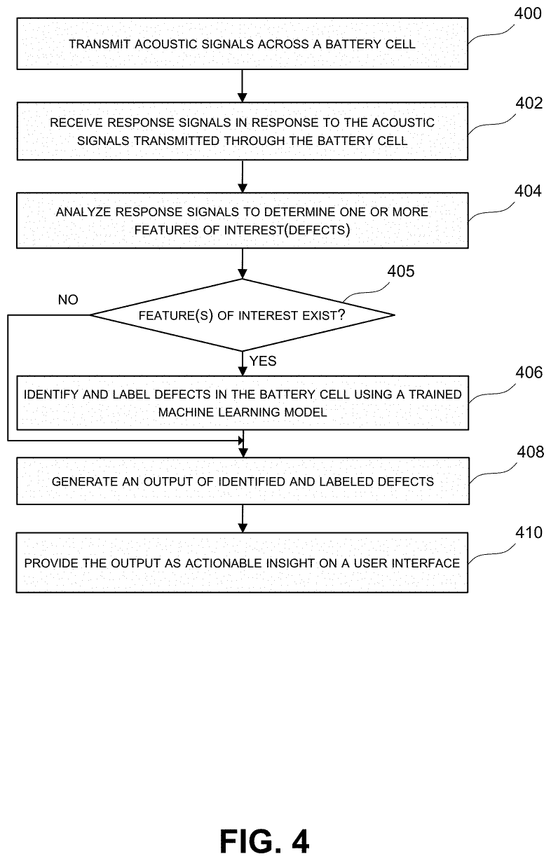

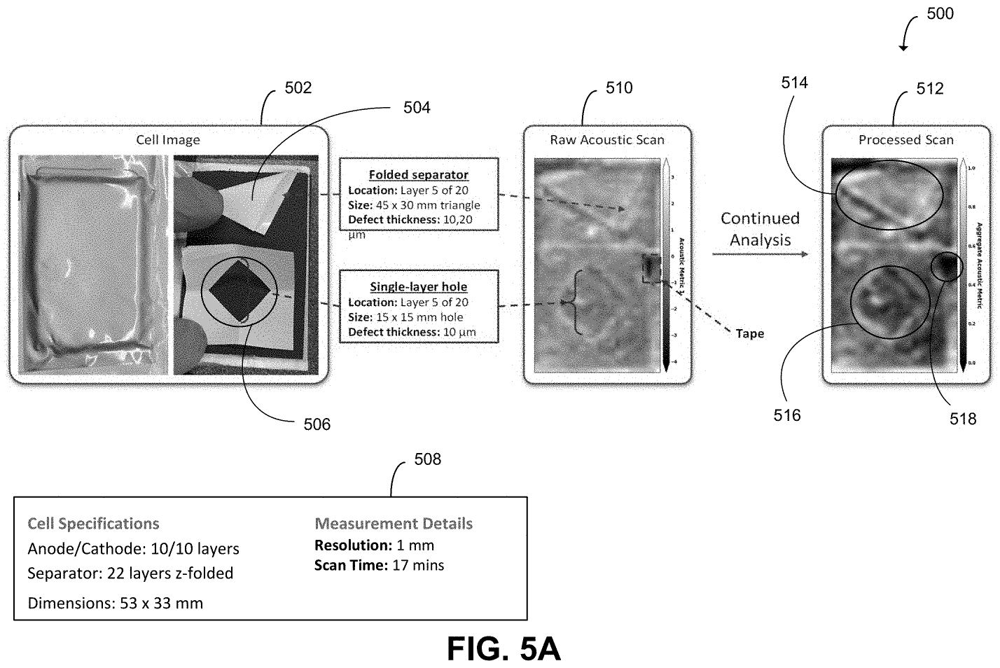

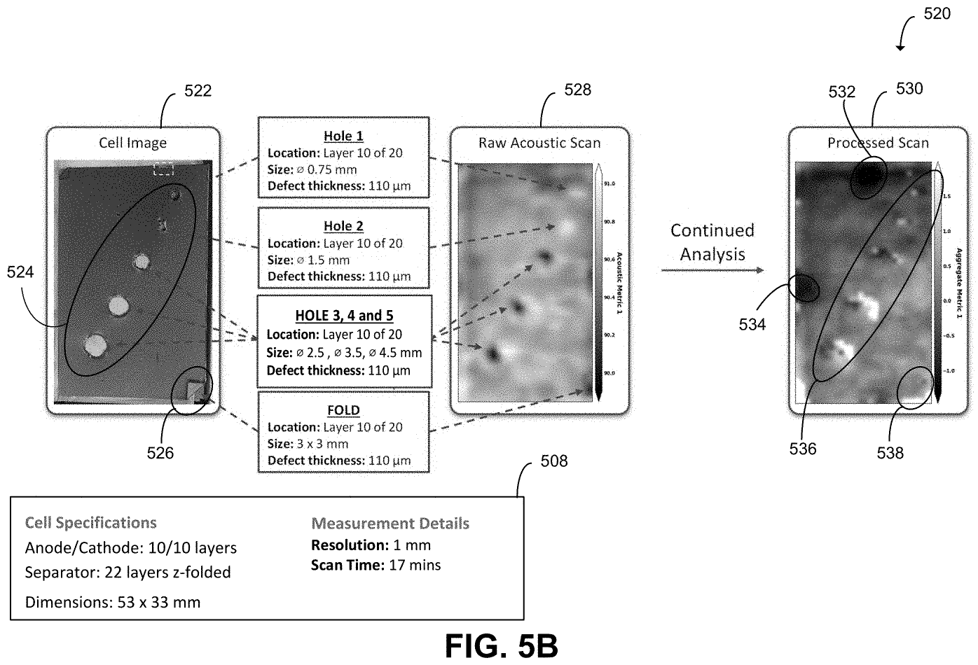

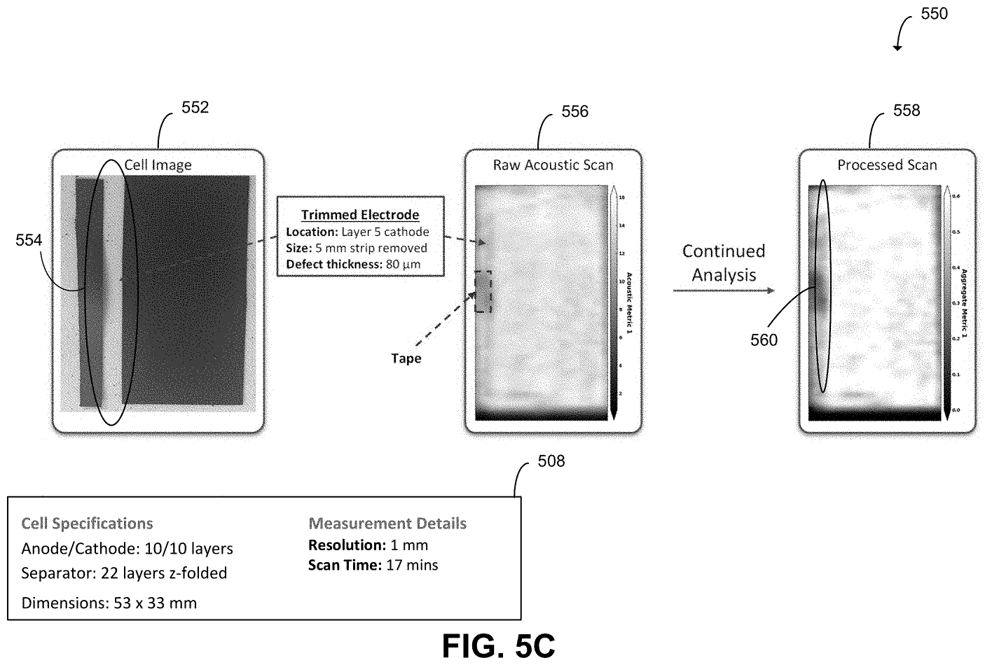

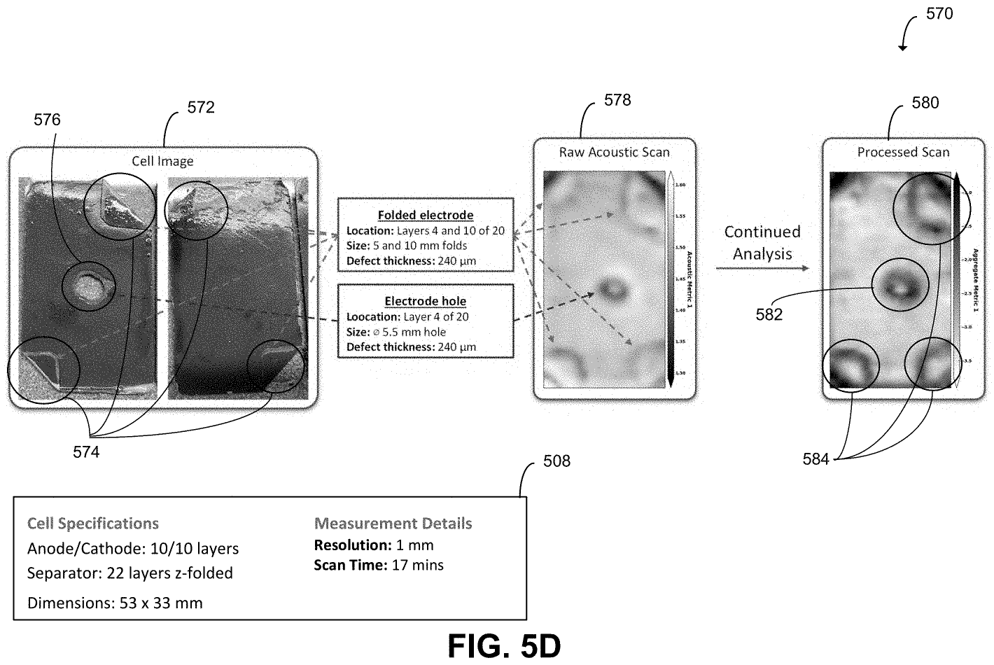

Stage 306 of process 300 may involve generating raw acoustic data of a scan of battery cell 304 based on the response signals received at stage 302. This will be further described below with reference to FIG. 4 and FIGS. 5A-D.

At stage 308, meaningful acoustic metrics indicative of physical defects present in one or more components of battery cell 304 may be obtained from the raw acoustic signals. Such physical characteristics include, but are not limited to, physical defects and/or foreign objects present inside battery cell 304 such as those enumerated above. Any known or to be developed signal pre-processing and analysis methodologies may be applied at this stage to process the raw acoustic signals and generate processed scans as will be described below with reference to FIGS. 5A-D. Example pre-processing and signal analysis for extraction of meaningful acoustic metrics include, but are not limited to, techniques developed by Liminal Insights Inc., of Emeryville, Calif. as described in U.S. application Ser. No. 17/112,756 filed on Dec. 4, 2020, the entire content of which is incorporated herein by reference.

Stage 310 of process 300 may involve providing the extracted acoustic metrics of stage 308 into a trained machine learning model to identify the type of each detected defect. In some examples, in addition to identification of the type of a defect, the machine learning model can be used to identify a location of the defect in battery cell 304.

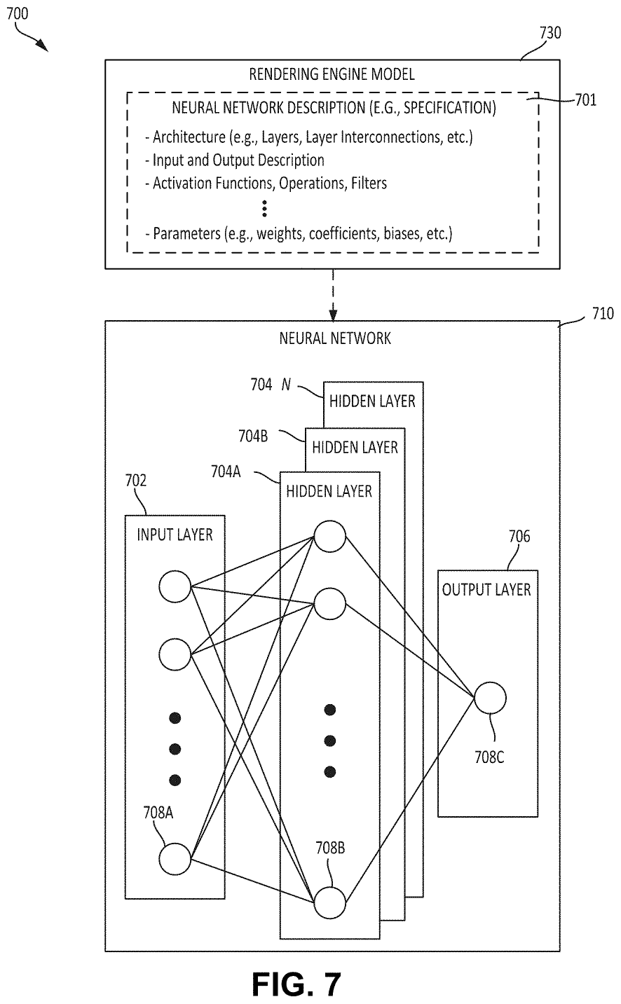

Training of such machine learning model will be further described below with reference to FIG. 7. The machine learning model may be trained using a database of acoustic measurements made of battery cells with known defects. In addition, and/or alternative to such training, the machine learning models used, may be updated using supervised learning techniques whereby results of defect detection and identification obtained in real-time, are used to constantly update and retrain the model to identify new and/or existing defects.

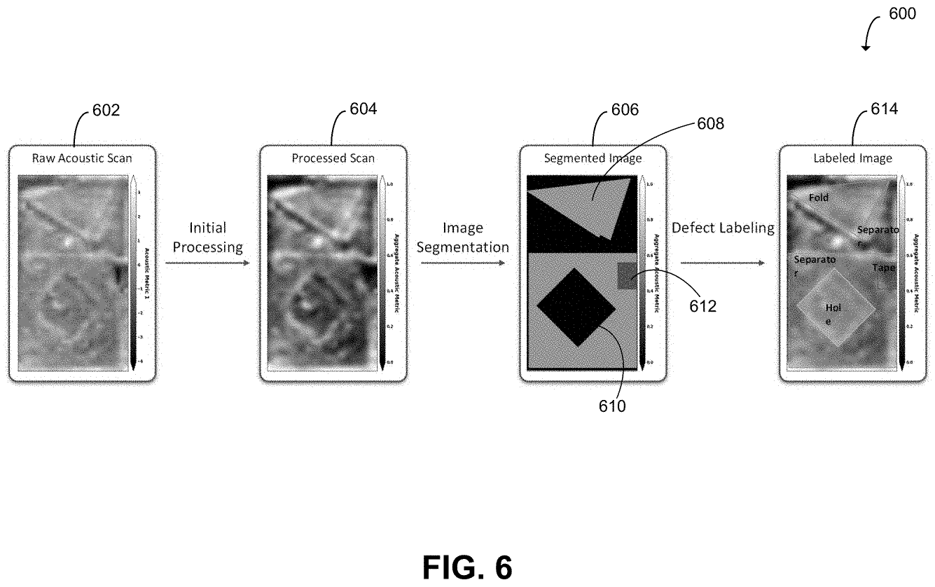

Stage 312 of process 300 may involve outputting and/or displaying actionable insights regarding defect detection and identification performed through stages 302-310. The actionable image can be presented in a form of a segmented and labeled image of battery cell 304, examples of which will be described below with reference to FIG. 6.

FIG. 4 illustrates an example method of defect detection and labeling according to some aspects of the present disclosure. The process of FIG. 4 will be described with reference to FIGS. 1-3. Furthermore, process of FIG. 4 will be described from the perspective of a controller such as processor 110 described with reference to FIGS. 1 and 2. However, the present disclosure is not limited thereto, and the process of FIG. 4 can be performed by any other processor that is communicatively coupled to one or more systems configured to acoustically inspect battery cells as they progress through the manufacturing process. Such processors may be cloud based and/or otherwise remotely located with respect to the inspection systems and communicatively coupled thereto.

At step 400, a controller may send one or more commands to one or more transmitters (e.g., a first subset of transducers such as transducer 104 and/or transducers 202) for transmitting acoustic signals through a battery cell such as battery cell 304, sample 102, etc.

In some examples, battery cell 304 through which the acoustic signals are transmitted is progressing through the cell manufacturing process, is at the end of the production line (e.g., has completed the different stages of battery cell manufacturing such as wetting, formation, aging, etc.), or is in a post-production stage (e.g., ready to be incorporated into a device for use or is already incorporated therein and is being used).

At step 402, the controller may receive response signals in response to the acoustic signals transmitted through the battery cell. The response signals may be received from one or more receiving transducers (e.g., a second subset of transducers such as transducer 106 and/or transducers 204).

In some example embodiments, transmission of the one or more commands at step 400 may be automatically triggered upon detection of an event such as placement of battery cell 304 at a designated position in between transmitting and receiving transducers such as transducers 104/106 and/or transducers 202/204.

At step 404, the controller may analyze the received response signals to determine (identify or detect) one or more acoustic metrics associated with one or more features of interest (e.g., possible or candidate defects) present in battery cell 304. This step may correspond to stages 306 and 308 of FIG. 3, where a raw acoustic scan of battery cell 304 is generated and then processed using known or to be developed techniques (such as techniques developed by Liminal Insights Inc., of Emeryville, Calif. as described in U.S. application Ser. No. 17/112,756 filed on Dec. 4, 2020, the entire content of which is incorporated herein by reference), to generate a processed scan of battery cell 304 and identify features of interest (e.g., possible defects in battery cell 304).

At step 405, the controller may determine if one or more features of interest are determined (identified or detected) at step 404. If not (NO at step 405), the process proceeds to step 408, which will be described below. When the controller determines that no feature of interest exists, this may be indicative of battery cell 304 being defect free.

However, if at step 405 the controller determines that at least one feature of interest exists (YES at step 405), the process proceeds to step 406 described below.

FIGS. 5A-D illustrate four non-limiting examples of defects identified in acoustic scan of battery cells according to some aspects of the present disclosure.

Example 500 of FIG. 5A illustrates battery cell 502 (may be the same as battery cell 304) with non-limiting defects of folded separators 504 and holes in pouch cells such as single-layer hole 506. As shown in FIG. 5A, battery cell 502 has the example cell specifications 508 (e.g., a battery cell with 10 layers of anode and cathode each and 22 layers of z-folded separators inserted therebetween. The overall dimensions of battery cell 502 is 53×33 mm. Specification 508 also indicates information about a specific type of acoustic scan performed on battery cell 502 (e.g., at a resolution of 1 mm with a total scan time of 17 minutes).

FIG. 5A also illustrates the specific characteristics and location of each type of defect in battery cell 502. For instance, folded separator 504 may be located in layer 5, having a triangle shape with a size of 45×30 mm and a thickness of 10, 20 μm. Single-layer hole 506 may be located in layer 5 as well, having a size of 15×15 mm and a thickness of 10 μm.

Raw acoustic scan 510 illustrates the presence of defects in battery cell 502 (e.g., folded separator 504 and single-layer hole 506, as well as a tape used to glue the layer of battery cell 502 together).

Cell specifications, measurement specifications, defect types and/or their respective characteristics illustrated in FIG. 5A and described above are mere examples and not intended to limit the scope of the disclosed defect detection and identification techniques of the present disclosure to such defects and/or relevant characteristics.

Raw acoustic scan 510 may then be processed per step 404 of FIG. 4 to produce/generate processed scan 512. Processed scan 512 presents a more visible and clearer visual of defects in battery cell 502 (e.g., folded separator 504 and single-layer hole 506, as well as a tape used to glue the layer of battery cell 502 together).

Processed scan 512 may include features of interest (features 514, 516, and 518) that can then be provided as input into a trained machine learning model so that type and location of the defects (e.g., folded separator 504 and single-layer hole 506, as well as a tape used to glue the layer of battery cell 502 together) can be determined. This will be further described with reference to remaining steps of FIG. 4 below.

In describing the non-limiting example of FIG. 5A, defects were identified from the beginning (e.g., when describing battery cell 502) for purposes of illustration. However, in practice, the defects are not known at the time of transmitting and receiving acoustic signals through battery cell 502 but that they will be identified after implementing defect detection and identification techniques of the present disclosure.

Example 520 of FIG. 5B illustrates battery cell 522 (may be the same as battery cell 304) with non-limiting defects of holes/punctures 524 in electrodes and a fold 526. As shown in FIG. 5B, battery cell 502 can have the same cell specifications 508 (e.g., a battery cell with 10 layers of anode and cathode each and 22 layers of z-folded separators inserted therebetween. The overall dimensions of battery cell 502 is 53×33 mm. Specification 508 also indicates information about a specific type of acoustic scan performed on battery cell 502 (e.g., at a resolution of 1 mm with a total scan time of 17 minutes). Cell specification for battery cell 522 need not be the same as that of battery cell 502 of FIG. 5A.

FIG. 5B also illustrates the specific characteristics and location of each type of defect in battery cell 502 including a specification of each hole/puncture in defect 524 and a specification of fold 526.

Raw acoustic scan 528 illustrates the presence of defects in battery cell 522 (e.g., holes/punctures 524, fold 526 and/or tapes or other foreign objects).

Cell specifications, measurement specifications, defect types and/or their respective characteristics illustrated in FIG. 5B and described above are mere examples and not intended to limit the scope of the disclosed defect detection and identification techniques of the present disclosure to such defects and/or relevant characteristics.

Raw acoustic scan 528 may then be processed per step 404 of FIG. 4 to produce/generate processed scan 530. Processed scan 530 presents a more visible and clearer visual of defects in battery cell 522 (e.g., holes/punctures 524, fold 526 and/or tapes and/or other foreign objects).

Processed scan 530 may include features of interest (features 532, 534, and 536) that can then be provided as input into a trained machine learning model so that type and location of the defects (e.g., holes/punctures 524, fold 526 and/or tapes and/or other foreign objects) can be determined. This will be further described with reference to remaining steps of FIG. 4 below.

In describing the non-limiting example of FIG. 5B, defects were identified from the beginning (e.g., when describing battery cell 522) for purposes of illustration. However, in practice, the defects are not known at the time of transmitting and receiving acoustic signals through battery cell 502 but that they will be identified after implementing defect detection and identification techniques of the present disclosure.

Example 550 of FIG. 5C illustrates battery cell 552 (may be the same as battery cell 304) with non-limiting defect of electrode misalignment 554. As shown in FIG. 5C, battery cell 552 can have the same cell specifications 508 (e.g., a battery cell with 10 layers of anode and cathode each and 22 layers of z-folded separators inserted therebetween. The overall dimensions of battery cell 502 is 53×33 mm. Specification 508 also indicates information about a specific type of acoustic scan performed on battery cell 502 (e.g., at a resolution of 1 mm with a total scan time of 17 minutes). Cell specification for battery cell 552 need not be the same as that of battery cell 502 of FIG. 5A and/or battery cell 522 of FIG. 5B.

FIG. 5C also illustrates the specific characteristics and location of electrode misalignment 554 in battery cell 502 including a specification thereof.

Raw acoustic scan 556 illustrates the presence of defects in battery cell 552 (e.g., electrode misalignment 554 and/or a tape).

Cell specifications, measurement specifications, defect types and/or their respective characteristics illustrated in FIG. 5C and described above are mere examples and not intended to limit the scope of the disclosed defect detection and identification techniques of the present disclosure to such defects and/or relevant characteristics.

Raw acoustic scan 556 may then be processed per step 404 of FIG. 4 to produce/generate processed scan 558. Processed scan 558 presents a more visible and clearer visual of defects in battery cell 552 (e.g., electrode misalignment 554 and/or the tape).

Processed scan 558 may include features of interest (feature 560) that can then be provided as input into a trained machine learning model so that type and location of the defects (e.g., electrode misalignment 554 and/or the tape) can be determined. This will be further described with reference to remaining steps of FIG. 4 below.

In describing the non-limiting example of FIG. 5C, defects were identified from the beginning (e.g., when describing battery cell 552) for purposes of illustration. However, in practice, the defects are not known at the time of transmitting and receiving acoustic signals through battery cell 502 but that they will be identified after implementing defect detection and identification techniques of the present disclosure.

Example 570 of FIG. 5D illustrates battery cell 572 (may be the same as battery cell 304) with non-limiting defect of a pouch cell with folded separators 574 and separator with hole 576. As shown in FIG. 5D, battery cell 572 can have the same cell specifications 508 (e.g., a battery cell with 10 layers of anode and cathode each and 22 layers of z-folded separators inserted therebetween. The overall dimensions of battery cell 502 is 53×33 mm. Specification 508 also indicates information about a specific type of acoustic scan performed on battery cell 502 (e.g., at a resolution of 1 mm with a total scan time of 17 minutes). Cell specification for battery cell 572 need not be the same as that of battery cell 502 of FIG. 5A, battery cell 522 of FIG. 5B, and/or battery cell 552 of FIG. 5C.

FIG. 5D also illustrates the specific characteristics and location of folded separators 574 and hole 576 including a specification of each.

Raw acoustic scan 578 illustrates the presence of defects in battery cell 572 (e.g., folded separators 574 and hole 576).

Cell specifications, measurement specifications, defect types and/or their respective characteristics illustrated in FIG. 5D and described above are mere examples and not intended to limit the scope of the disclosed defect detection and identification techniques of the present disclosure to such defects and/or relevant characteristics.

Raw acoustic scan 578 may then be processed per step 404 of FIG. 4 to produce/generate processed scan 580. Processed scan 580 presents a more visible and clearer visual of defects in battery cell 572 (e.g., folded separators 574 and hole 576).

Processed scan 580 may include features of interest (features 582 and 584) that can then be provided as input into a trained machine learning model so that type and location of the defects (e.g., folded separators 574 and hole 576) can be determined. This will be further described with reference to remaining steps of FIG. 4 below.

In describing the non-limiting example of FIG. 5D, defects were identified from the beginning (e.g., when describing battery cell 572) for purposes of illustration. However, in practice, the defects are not known at the time of transmitting and receiving acoustic signals through battery cell 502 but that they will be identified after implementing defect detection and identification techniques of the present disclosure.

FIGS. 5A-D illustrate several non-limiting examples of obtaining an acoustic scan of a battery cell through transmission of acoustic signals and processing the same to identify features of interest, per steps 400-404 of FIG. 4.

Referring back to FIG. 4, at step 406, the controller may identify and label defects in the battery cell using a trained machine learning model. Training of a machine learning model will be further described below with reference to FIG. 7. In one example, such trained machine learning model may receive, as input, identified features of interest (e.g., features 514, 516, and 518 of FIG. 5A; features 532, 534, 536, and 538 of FIG. 5B; feature 560 of FIG. 5C; and features 582 and 584 of FIG. 5D). The output of the machine learning model can be identification of type and location of each feature of interest (defect) in the battery cell under testing.

In some examples, while features of interest may have been identified at step 404, the process at step 406 may result in no known defect being identified and labeled. In other words, a feature of interest identified at step 404 may not be an actual defect (e.g., can be a false positive) and hence the outcome of step 406 may be that battery cell such as battery cell 304 is defect free.

At step 408, the controller may generate an output that is a labeled and segmented version of battery cell under testing with the identified defects (or a version of battery cell 304 with no defect if the outcome of step 405 is a NO as described above). FIG. 6 illustrates an example of a labeled and segmented image of a battery cell with identified defects according to some aspects of the present disclosure.

In example 600 of FIG. 6, raw acoustic scan 602 and/or processed scan 604 (several examples of which have been described above with reference to FIGS. 5A-D) may be provided as input into a trained machine learning model. In one example, the input into the machine learning model can be the raw acoustic and/or processed scan (with no identification of features of interest) or alternatively can include an identification of features of interest (e.g., features 514, 516, and 518 of FIG. 5A; features 532, 534, 5366, and 538 of FIG. 5B; feature 560 of FIG. 5C; and features 582 and 584 of FIG. 5D).

The trained machine learning model may then generate segmented image 606 that locates possible/candidate defects (e.g., candidate defects 608, 610, and/or 612). Labeled image 614 may then be generated with a label for each candidate defect (e.g., candidate defect 608 is labeled as a fold, candidate defect 610 is labeled as a hole, and candidate defect (foreign object) 612 is identified as a tape. Labeled image 614 may also specify locations or layers in which the identified defects are located (e.g., the two separators identified in labeled image 614).

Additionally, depending on the type of acoustic measurement that is taken, a 3-Dimensional tomographic reconstruction of a battery cell or cells under testing can be created that provides the depth, as well as planar location, of the labeled defect(s). This allows for greater insights into which specific part of the manufacturing process may be responsible for/causing the presence of detected defects.

Labeled image 614 may be the generated output at step 408. At step 410, the generated output may be provided for display, as actionable insight, on a user interface associated with the controller and/or more generally with system 100 and/or system 200. The user interface may be provided on a monitor of a desktop and/or a laptop communicatively coupled to system 100 and/or system 200, may be displayed on a mobile device communicatively coupled to system 100 and/or system 200, etc.

In some examples, the labeled image 614 displayed on a user interface, can assist an operator of system 100 and/or system 200 to flag a tested battery cell, such as battery cell 304, as being defective and that a corrective action with respect to battery cell 304 may be warranted. Such corrective action can be, but is not limited to, disposing of battery cell 304 depending on the type of defect detected, repurposing/classifying battery cell 304 for use in a different type of application that originally intended, depending on the type of defect detected, etc. In another example and for battery cells tested during production, identified defect(s) can assist battery manufacturer to revise/modify one or more processes of battery manufacturing (e.g., cell assembly process, wetting process, formation process, etc.) to reduce/eliminate the identified defects in battery cells caused by the underlying manufacturing process.

In some examples, if battery cell 304 with one or more identified defects is or has been in use in a post-production stage and depending on the type of defect detected, battery cell 304 may be designated for specific second-life use, may be disposed of, etc.

In some examples, the corrective actions may be implemented manually by an operator of system 100 and/or system 200. In some examples, the corrective action may be suggested by/implemented by system 100/system 200 automatically. For instance, system 100 and/or system 200 may suggest a corrective action (e.g., battery cell 304 should be disposed/recycled, battery cell 304 should be designated for use in application X or Y, etc.).

In some examples, the trained machine learning model described above or alternatively a separately trained machine learning model may be utilized to recommend a corrective action. In this instance, the model may receive as input the labeled image 614 and provide as output a recommended corrective action to be taken with respect to the battery cell tested.

FIG. 7 illustrates an example neural network that can be utilized for labeling and location defects according to some aspects of the present disclosure. In some examples, such neural network can also be trained to perform the process at step 404 (i.e., receive a processed image, identify features of interest (possible defects), and label and locate the defects). In another example, example neural networks of FIG. 7 can be utilized to also recommend a corrective action. In another example, a separate neural network may be trained to recommend a corrective action.

Architecture 700 includes a neural network 710 defined by an example neural network description 701 in rendering engine model (neural controller) 730. Neural network 710 can be used for determining an SEI formation score for battery cell 304 as described above with reference to FIGS. 3-6A-D. Neural network description 701 can include a full specification of neural network 710. For example, neural network description 701 can include a description or specification of the architecture of neural network 710 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

In this example, neural network 710 includes an input layer 702, which can receive input data including, but not limited to, raw scans of a battery cell that are generated based on response signals received (e.g., raw acoustic scan 510 of FIG. 5A, raw acoustic scan 528 of FIG. 5B, raw acoustic scan 556 of FIG. 5C and/raw acoustic scan 578 of FIG. 5D). In some examples, the input data can be the processed scans of the raw acoustic scans (e.g., processed scan 512 of FIG. 5A, processed scan 530 of FIG. 5B, processed scan 558 of FIG. 5C, and/or processed scan 580 of FIG. 5D). In another example, the input data can be the mentioned raw acoustic scans and/or processed scans along with identification of features of interest (e.g., possible defects such as features 514, 516, and 518 of FIG. 5A; features 532, 534, 5366, and 538 of FIG. 5B; feature 560 of FIG. 5C; and features 582 and 584 of FIG. 5D).

Neural network 710 includes hidden layers 704A through 704N (collectively “504” hereinafter). Hidden layers 704 can include n number of hidden layers, where n is an integer greater than or equal to one. The number of hidden layers can include as many layers as needed for a desired processing outcome and/or rendering intent. Neural network 710 further includes an output layer 706 that provides as output, labeled and/or located defects in a scanned battery cell. The output can additionally or alternatively be a recommended corrective actions, as described above.

Neural network 710 in this example is a multi-layer neural network of interconnected nodes. Each node can represent a piece of information. Information associated with the nodes is shared among the different layers and each layer retains information as information is processed. In some cases, neural network 710 can include a feed-forward neural network, in which case there are no feedback connections where outputs of the neural network are fed back into itself. In other cases, neural network 710 can include a recurrent neural network, which can have loops that allow information to be carried across nodes while reading in input.

Information can be exchanged between nodes through node-to-node interconnections between the various layers. Nodes of input layer 702 can activate a set of nodes in first hidden layer 704A. For example, as shown, each of the input nodes of input layer 702 is connected to each of the nodes of first hidden layer 704A. The nodes of hidden layer 704A can transform the information of each input node by applying activation functions to the information. The information derived from the transformation can then be passed to and can activate the nodes of the next hidden layer (e.g., 704B), which can perform their own designated functions. Example functions include convolutional, up-sampling, data transformation, pooling, and/or any other suitable functions. The output of the hidden layer (e.g., 704B) can then activate nodes of the next hidden layer (e.g., 704N), and so on. The output of the last hidden layer can activate one or more nodes of output layer 706, at which point an output is provided. In some cases, while nodes (e.g., nodes 708A, 708B, 708C) in neural network 710 are shown as having multiple output lines, a node has a single output and all lines shown as being output from a node represent the same output value.

In some cases, each node or interconnection between nodes can have a weight that is a set of parameters derived from training neural network 710. For example, an interconnection between nodes can represent a piece of information learned about the interconnected nodes. The interconnection can have a numeric weight that can be tuned (e.g., based on a training dataset), allowing neural network 710 to be adaptive to inputs and able to learn as more data is processed.

Neural network 710 can be pre-trained to process the features from the data in the input layer 702 using the different hidden layers 704 in order to provide the output through output layer 706. In this example, neural network 710 can be trained using training data. The training data can be a subset of data stored in a database of simulated defects and corresponding acoustic features, prior detected defects and their corresponding acoustic features, etc.). Another subset of the data stored in such database can be used for purposes of validating the training of neural network 710. For instance, a batch of (e.g., 10, 100, 1000) battery cells with known defects (and/or defected inserted therein) may be acoustically measured and the corresponding raw acoustic scan and/or processed scans may be examined to identify, label, and/or locate the known defects within the tested batteries. The acoustic measurements of the tested battery cells may be based on specific or different testing conditions and cell specifications of the battery cells may be the same or different.

The results (or a subset thereof) from acoustic measurements of the batch of battery cells along with the identified, labeled, and/or located defects may be used as training data for training neural network 710. Another subset may be used for validating the training of neural network 710.

Training data can also include corrective actions recommended for each identified, labeled, and located defect such that in addition to identifying, labeling, and/or locating defects, neural network 710 can also provide, as output, a recommended corrective action as described above. As mentioned, a separate neural network 710 may be trained to only provide the recommended corrective action as output.

In one or more examples, training of neural network 710 may be supervised, whereby the model is trained using labeled datasets whereby one or more aspects of neural network 710, such as weights, biases, etc., are tuned until neural network 710 returns the expected result for a given type of battery cell. In other examples, the training may be unsupervised.

In some examples, the training may be based on zero-shot learning and/or transfer learning.

In some cases, neural network 710 can adjust weights of nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For a first training iteration for neural network 710, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, neural network 710 is unable to determine low level features and thus cannot make an accurate determination of what the classification of the object might be. A loss function can be used to analyze errors in the output. Any suitable loss function definition can be used.

The loss (or error) can be high for the first training dataset (e.g., images) since the actual values will be different than the predicted output. The goal of training is to minimize the amount of loss so that the predicted output comports with a target or ideal output. Neural network 710 can perform a backward pass by determining which inputs (weights) most contributed to the loss of neural network 710 and can adjust the weights so that the loss decreases and is eventually minimized.

A derivative of the loss with respect to the weights can be computed to determine the weights that contributed most to the loss of neural network 710. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

Neural network 710 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, neural network 710 can represent any other neural or deep learning network, such as an autoencoder, a deep belief network (DBN), a recurrent neural network (RNN), etc.

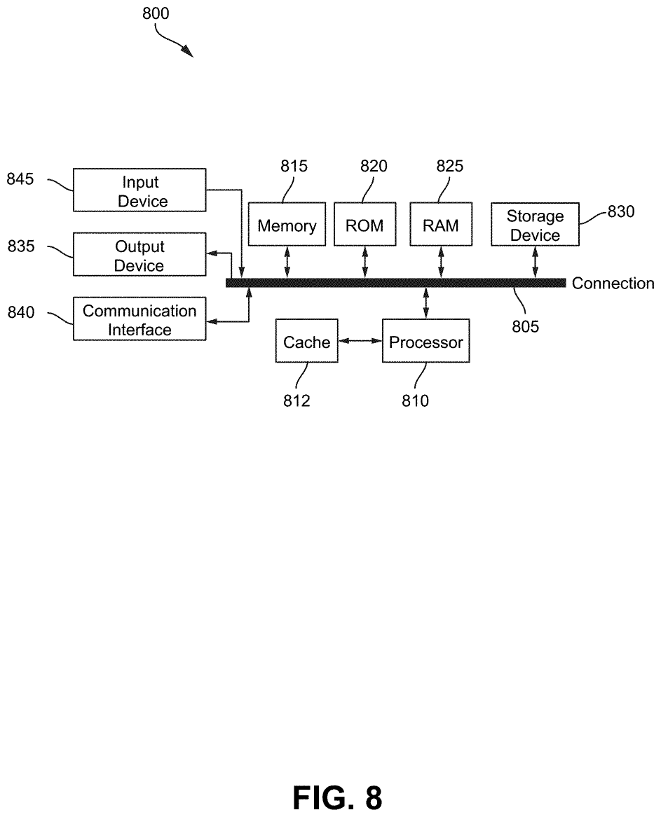

FIG. 8 illustrates an example computing device architecture of an example computing device according to some aspects of the disclosure. Device architecture 800 of an example computing device which can be used as various components of system 100 or 200 (e.g., processor 110) implement various techniques described herein. The components of the computing device architecture 800 are shown in electrical communication with each other using a connection 805, such as a bus. The example computing device architecture 800 includes a processing unit (CPU or processor) 810 and a computing device connection 805 that couples various computing device components including the computing device memory 815, such as read only memory (ROM) 820 and random access memory (RAM) 825, to the processor 810.

The computing device architecture 800 can include a cache of high-speed memory connected directly with, in close proximity to, or integrated as part of the processor 810. The computing device architecture 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other computing device memory 815 may be available for use as well. The memory 815 can include multiple different types of memory with different performance characteristics. The processor 810 can include any general-purpose processor and a hardware or software service stored in storage device 830 and configured to control the processor 810 as well as a special-purpose processor where software instructions are incorporated into the processor design. The processor 810 may be a self-contained system, containing multiple cores or processors, a bus, memory controller, cache, etc. A multi-core processor may be symmetric or asymmetric.

To enable user interaction with the computing device architecture 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art, such as a display, projector, television, speaker device. In some instances, multimodal computing devices can enable a user to provide multiple types of input to communicate with the computing device architecture 800. The communication interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof. The storage device 830 can include software, code, firmware, etc., for controlling the processor 810. Other hardware or software modules are contemplated. The storage device 830 can be connected to the computing device connection 805. In one aspect, a hardware module that performs a particular function can include the software component stored in a computer-readable medium in connection with the necessary hardware components, such as the processor 810, connection 805, output device 835, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A non-invasive method of identifying and labeling defects in a battery cell, the method comprising:
transmitting acoustic signals through a battery cell via one or more first transducers;
receiving response signals in response to the acoustic signals at one or more second transducers;
determining whether at least one feature of interest exists in the battery cell based on analyzing the response signals;
performing an identification and labeling process on the at least one feature of interest to determine at least one defect in the battery cell; and
outputting a result of the identification and labeling process.

2. The method of claim 1, wherein the identification and labeling process is performed using a trained machine learning model.

3. The method of claim 2, wherein the machine learning model receives as input, at least one of the response signals and the at least one feature of interest and provides at least one labeled defect corresponding to the at least one feature, as output.

4. The method of claim 1, wherein the identification and labeling process determines at least one of a corresponding type for the at least one defect and a corresponding location of the at least one defect in the battery cell.

5. The method of claim 1, wherein the at least one defect is one or more of a fold, a wrinkle, one or more holes in materials forming the battery cell, cracks or fractures in solid-state ceramic based separators of the battery cell, dry spots within the battery cell, electrode holes, folds, delamination, or layer misalignment, foreign object debris, burrs, metallic particle inclusions, tab defects including tears, folds, and poor quality welds, plating of lithium metal on anode material of the battery cell, evolution of gasses resulting from electrolyte or other chemical decomposition.

6. The method of claim 1, wherein the output is a segmented visual rendering of the battery cell with the least one defect labeled therein.

7. The method of claim 1, further comprising:
determining a corrective action to be taken with respect to the battery cell based on the result of the identification and the labeling process.

8. A system comprising:
a plurality of transducers configured to at least one of transmit and receive acoustic signals through a battery cell; and
a controller communicatively coupled to the plurality of transducers and configured to:
control a first subset of the plurality of transducers to transmit acoustic signals through the battery cell;
control a second subset of the plurality of transducers to receive response signals in response to the acoustic signals;
determine whether at least one feature of interest exists in the battery cell based on analyzing the response signals;
perform an identification and labeling process on the at least one feature of interest to determine at least one defect in the battery cell; and
output a result of the identification and labeling process.

9. The system of claim 8, wherein the controller is configured to perform the identification and labeling process is performed using a trained machine learning model.

10. The system of claim 9, wherein the machine learning model receives as input, at least one of the response signals and the at least one feature of interest and provides at least one labeled defect corresponding to the at least one feature, as output.

11. The system of claim 8, wherein the controller is configured to perform the identification and labeling process to determine at least one of a corresponding type for the at least one defect and a corresponding location of the at least one defect in the battery cell.

12. The system of claim 8, wherein the at least one defect is one or more of a fold, a wrinkle, one or more holes in materials forming the battery cell, cracks or fractures in solid-state ceramic based separators of the battery cell, dry spots within the battery cell, electrode holes, folds, delamination, or layer misalignment, foreign object debris, burrs, metallic particle inclusions, tab defects including tears, folds, and poor quality welds, plating of lithium metal on anode material of the battery cell, evolution of gasses resulting from electrolyte or other chemical decomposition.

13. The system of claim 8, wherein the output is a segmented visual rendering of the battery cell with the least one defect labeled therein.

14. The system of claim 8, wherein the controller is configured to determine a corrective action to be taken with respect to the battery cell based on the result of the identification and the labeling process.

15. One or more non-transitory computer-readable media comprising computer-readable instructions, which when executed by a controller of a system for non-invasive inspection of batteries, cause the controller to:
control a first subset of a plurality of transducers to transmit acoustic signals through a battery cell;
control a second subset of the plurality of transducers to receive response signals in response to the acoustic signals;
determine whether at least one feature of interest exists in the battery cell based on analyzing the response signals;
perform an identification and labeling process on the at least one feature of interest to determine at least one defect in the battery cell; and
output a result of the identification and labeling process.

16. The one or more non-transitory computer-readable media of claim 15, wherein the execution of the computer-readable instructions causes the controller to perform the identification and labeling process using a trained machine learning model.

17. The one or more non-transitory computer-readable media of claim 16, wherein the machine learning model receives as input, at least one of the response signals and the at least one feature of interest and provides at least one labeled defect corresponding to the at least one feature, as output.

18. The one or more non-transitory computer-readable media of claim 15, wherein the execution of the computer-readable instructions causes the controller to perform the identification and labeling process to determine at least one of a corresponding type for the at least one defect and a corresponding location of the at least one defect in the battery cell.

19. The one or more non-transitory computer-readable media of claim 15, wherein the at least one defect is one or more of a fold, a wrinkle, one or more holes in materials forming the battery cell, cracks or fractures in solid-state ceramic based separators of the battery cell, dry spots within the battery cell, electrode holes, folds, delamination, or layer misalignment, foreign object debris, burrs, metallic particle inclusions, tab defects including tears, folds, and poor quality welds, plating of lithium metal on anode material of the battery cell, evolution of gasses resulting from electrolyte or other chemical decomposition.

20. The one or more non-transitory computer-readable media of claim 15, wherein the execution of the computer-readable instructions causes the controller to determine a corrective action to be taken with respect to the battery cell based on the result of the identification and the labeling process.
